(19) United States
(12) Patent Application Publication
(10) Pub. No.: US 2025/0094507 A1
(43) Pub. Date: Mar. 20, 2025

(54) PROFILE MATCHING FILTERS

(71) Applicant: PAYPAL, INC., San Jose, CA (US)

(72) Inventors: Pengshuang Hu, Shanghai (CN); Ligang Chen, Shanghai (CN)

(21) Appl. No.: 18/470,779

(22) Filed: Sep. 20, 2023

(51) Int. Cl. G06F 16/9535; H04L 67/306

(52) U.S. Cl. CPC G06F 16/9535; G06F 16/24568

(57) ABSTRACT

Methods and systems are presented for providing a framework for performing profile matching processes on multiple user accounts. Filters are generated based on account data associated with the user accounts, where each filter includes information that indicates presences of various attribute values in the account data that corresponds to a particular attribute type. In response to detecting a matching event, profile data associated with a set of profiles is matched against the account data using the filters. A portion of the profile data is extracted from each profile. One or more functions associated with a filter is applied to the portion of the profile data to generate a set of filter keys. A match between at least one user account and the profile is determined based on values that correspond to the set of filter keys in the filter.

### BACKGROUND

The present specification generally relates to computer-based data matching, and more specifically, to providing a framework for improving computer resource efficiency in matching a large amount of data according to various embodiments of the disclosure.

### RELATED ART

Service providers that operate in an online space often collect, store, and manage a large amount of data (e.g., user data associated with their users, etc.). Due to compliance obligations or otherwise regular business operations, a service provider may desire to determine matches between its users and one or more predetermined profiles. The profiles may be associated with a particular known category of users, such that the service provider may perform one or more actions associated with or to accounts of the users that are matched with the one or more profiles. The service provider may be requested to identify the matched users quickly (e.g., within a time threshold), such that actions can be performed swiftly, and in some cases, be performed in real-time.

However, due to the large amount of data to be analyzed (e.g., matched with the profiles), conventional data matching algorithms typically require a substantial amount of computer resources and/or time to perform the matching process, which can result in undesirable consequences, such as performing improper actions or not performing any actions that lead to processing fraudulent transactions, exposing sensitive data to unauthorized users, or providing content that is not beneficial or useful to users. Thus, there is a need for providing a framework that improves the computer resource efficiency for performing user data matching.

### BRIEF DESCRIPTION OF THE FIGURES

FIG. 1 is a block diagram illustrating an electronic transaction system according to an embodiment of the present disclosure;

FIG. 2 is a block diagram illustrating a computing environment in which a profile matching system may operate according to an embodiment of the present disclosure;

FIG. 3 illustrates the generation of indices and filters based on user account data according to an embodiment of the present disclosure;

FIG. 4A illustrates an example of incorporation data into a filter according to an embodiment of the present disclosure;

FIG. 4B illustrates another example of incorporating data into a filter according to an embodiment of the present disclosure;

FIG. 4C illustrates an example of using a filter to determine whether an attribute value is present in the user account data according to an embodiment of the present disclosure;

FIG. 4D illustrates another example of using a filter to determine whether an attribute value is present in the user account data according to an embodiment of the present disclosure;

FIG. 4E illustrates an example of removing data from a filter according to an embodiment of the present disclosure;

FIG. 5 illustrates the generation of indices and filters based on profile data according to an embodiment of the present disclosure;

FIG. 6 is a flowchart showing a process of generating indices and filters for performing profile matching processes according to an embodiment of the present disclosure;

FIG. 7 is a flowchart showing a process of performing a profile matching process according to an embodiment of the present disclosure;

FIG. 8 is a flowchart showing a process of using a filter to determine a presence of an attribute value in a data set according to an embodiment of the present disclosure;

FIG. 9 is a flowchart showing a process of removing data from a filter according to an embodiment of the present disclosure; and

FIG. 10 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a framework for matching user data against a set of profiles. As discussed herein, a service provider often desires to identify users that match one or more profiles. The service provider may generate, or otherwise obtain, a set of profiles corresponding to one or more categories of users. In one example, the set of profiles may include profiles that correspond to malicious users, and each of the profiles may store attributes associated with a known malicious user (e.g., a name, a phone number, a residential address, a network address, etc.). When it is determined that a user shares one or more attributes with a profile, the service provider may determine that the user is a malicious user. The service provider may then perform one or more actions associated with or to the user accounts associated with the users that were matched with one or more of the profiles (e.g., suspending the user accounts, increasing a security level associated with the user accounts, etc.). In another example, the set of profiles may include profiles that correspond to target users for a product and/or service recommendation, and each of the profiles may store attributes associated with the target users who would be interested in the product or the service (e.g., an age range, a location, a purchase history, etc.). When it is determined that a user shares one or more attributes with a profile, the service provider may determine that the user is a targeted user for the product and/or service recommendation. The service provider may then perform one or more actions to the user accounts associated with the users that were matched with one or more of the profiles (e.g., transmitting electronic data corresponding to the product and/or service recommendation to devices associated with the users, etc.).

Conventionally, in order to determine whether any user is a match with a set of profiles, the data in each of the profiles is required to be compared against the user data of each user. Assuming there are y number of users to be matched with x number of profiles, as many as (xx y) comparison operations are required to be performed. The number of comparison operations can become very large when the number of users associated with the service provider (or the number of profiles) is large (several hundreds of thousands of users, millions of users, etc.). It would require a substantial amount of computer resources and time to perform such a large number of comparison operations, which may render the matching process impractical especially when the service provider needs to perform the matching process on a regular basis.

As such, according to various embodiments of the disclosure, a framework for using filters in the process of matching user data against a set of profiles is provided. In some embodiments, instead of directly comparing the user data against the profiles, a profile matching system may use one or more filters to quickly determine whether any user corresponds to one of the profiles. Each filter may include a data structure that stores information that indicates whether certain data appears in a data set (e.g., user data of the users with the service provider), but does not include the data itself. Such a data structure is beneficial as it can be compact in size (since it does not store all of the data in the data set, but only information that indicates which data is included in the data set), and enables the profile matching system to determine whether certain data exists within the data set by performing a small set of operations quickly regardless of the size of the dataset.

In some embodiments, the profile matching system may generate a filter for each attribute type within the data set, such that the profile matching system may determine presences of different attribute values corresponding to different attribute types independently. For example, the profile matching system may generate a filter (e.g., a name filter) to represent names of the users of the service provider. In this example, the profile matching system may use the name filter to determine whether any of the users of the service provider has a particular name (e.g., “Joe Smith”). The profile matching system may also generate another filter (a network address filter) to represent network addresses (e.g., an Internet Protocol (IP) address) associated with devices used by the users of the service provider. In such an example, the profile matching system may use the network address filter to determine whether a particular network address (e.g., an IP address of “162.3.4.24”) is associated with any device used by the users of the service provider.

One of the advantages for dividing the user data into different filters corresponding to different attribute types is that the matching process can be conducted based on any attribute value corresponding to any attribute type, regardless of the availability of other attribute types. For example, when generating a profile corresponding to a malicious user, the data associated the malicious user may not always be complete. In some cases, only a small portion of data (e.g., only a network address, only a phone number, etc.) is available. The generation of multiple filters corresponding to different attribute types enables the profile matching system to perform the matching process even with limited amount of data within a profile.

In some embodiments, a filter can be implemented using a data structure (e.g., a vector, an array of values, etc.) storing values that indicates the presence of different data in the data set. The filter may have m dimensions (e.g., an array of m values, etc.) corresponding to m number of keys (also referred to herein as “filter keys”). For example, the filter may include filter keys within the range of 0 and (m−1). The filter may also be associated with one or more functions (e.g., hash functions), which can be used to map data to different filter keys (e.g., k number of keys) of the filter.

In order to build a filter for a data set (e.g., user data associated with users of the service provider), the profile matching system may generate the data structure having m dimensions (e.g., 50, 100, 500, etc.). Each value in the array may correspond to a distinct filter key (e.g., a key range between 0 and (m−1)) that represents the location of the value within the array. All of the values may be initialized as zeros at first. The profile matching system may also define one or more functions for the filter. The one or more functions may be used by the profile matching system to determine (e.g., identify) k filter keys for a given data. The one or more functions may include different hash functions such that each function may map the same piece of data to a different filter key of the filter.

The profile matching system may then incorporate information from the data set into the filter by iteratively modifying the filter based on data in the data set. For example, if the filter is configured to represent the presence of names within the user data of users associated with the service provider, the profile matching system may access the name of each user from the data set. The profile matching system may perform the one or more functions on the name of a user to generate a set of k filter keys (where k can be 3, 5, 10, or other numbers). In some embodiments, the one or more functions may include different hash functions configured to generate different values representing different filter keys based on input data (e.g., a name). By applying the different hash functions to the name, a set of filter keys (e.g., k filter keys) may be generated. The profile matching system may increment the values corresponding to the set of filter keys in the filter (e.g., incrementing by 1). The profile matching system may continue to modify the filter (e.g., incrementing different values in the array) based on the names of other users in the data set.

After incorporating the information from the user data set into the filter (e.g., the name filter), the profile matching system may begin using the filter for the matching process. For example, to determine whether a name in a profile matches any names of the users with the service provider, the profile matching system may apply the one or more functions to the name in the profile to generate a set of filter keys. The profile matching system may access the values in the filter that correspond to the filter keys. In some embodiments, the profile matching system may determine that the name is absent from the data set when any one of the values is zero. The profile matching system may also determine that the name is likely present in the user data set when all of the values are non-zeros.

It is noted that using the filter disclosed herein to perform the matching process may produce false positive results. For example, the one or more functions may produce identical sets of filter keys based on two different data (e.g., two different names). Typically, having a larger number of values in the filter (e.g., a larger m) and/or a larger number of functions used to generate the filter keys (e.g., a larger k) may reduce the false positive rate for the filter, as the larger m and k values would reduce the chance that the functions would map different data (e.g., different names) to the same set of filter keys. As such, the profile matching system may determine the parameters (e.g., the m value and the k value) associated with the filter in order to achieve an acceptable false positive rate (e.g., a false positive rate below a threshold). In some embodiments, the profile matching system may determine the parameters for the filter based on different factors, such as the size of the data set (e.g., the number of records in the data set), the size of different attribute values corresponding to the attribute type within the data set, the attribute type associated with the filter, and a false positive rate threshold, such that the filter may enable the profile matching system to provide matching results having a false positive rate below the false positive rate threshold.

By using the filters, the profile matching system of some embodiments may quickly determine either (i) no user corresponds to any profile or (ii) a high likelihood (with an acceptable false positive rate) that at least one user corresponds to a profile. In some embodiments, the filters enable the profile matching system to make such a determination based on a constant number of operations (e.g., less than five, less than ten, etc.), regardless of the size of the data set. This is a substantial improvement to the performance of the profile matching process, as the total number of computer operations required to perform a conventional profile matching process depends on the size of the data set. Consider a data set that represents user data of 1 million users, the conventional profile matching process would require 1 million computer operations (e.g., a comparison operations) to determine whether any users correspond to a profile, whereas the profile matching process using the techniques described herein would require only a much smaller constant number of operations (e.g., less than five, less than ten, etc.).

In some embodiments, the profile matching system may generate different filters for different attribute types in the data set using the techniques described herein. For example, the profile matching system may generate a name filter to represent the names of the users of the service provider, a phone number filter to represent the phone numbers of the users, a network address filter to represent the network addresses associated with devices used by the users, and so forth. The profile matching system may incorporate the information of the data set within the various filters. To perform the profile matching process, the profile matching system may first perform a preliminary matching process using the various filters that were generated to represent the various attribute types stored in the user data set. The profile matching system may access the attribute values in each of the profiles, and may use the corresponding filters to determine whether any user(s) of the service provider matches each of the profiles.

For example, the profile matching system may apply the one or more functions to an attribute value of the profile (e.g., the name in the profile) to generate a set of filter keys. The profile matching system may access the values in the corresponding filter based on the filter keys, and may determine whether any user(s) of the service provider matches the profile (or a likelihood that any user(s) matches the profile) based on the values in the filters (e.g., by determining whether all of the values are non-zeros or larger than zero, etc.). The profile matching system may perform the same steps for other attribute values in the profile (e.g., the phone number, the network address, etc.). If it is determined that no users match a particular profile, the profile matching system may skip the particular profile, and perform the preliminary matching process based on the next profile.

On the other hand, if it is determined that the particular profile matches at least one user of the service provider based on the filters, the profile matching system may perform a secondary matching process. The secondary matching process is more in-depth, and requires substantially more computer resources and time to perform. In some embodiments, the secondary matching process is similar to a conventional matching process, in which the attribute values of the particular profile are compared against the attribute values associated with each of the users with the service provider. In some embodiments, the profile matching system may generate one or more search indices for assisting in the secondary matching process. The one or more indices may be implemented as an inverted index or a storage-based index, such that the profile matching system may identify a user account that matches a profile by querying the one or more indices based on an attribute value of the profile.

Based on performing the secondary matching process, the profile matching system may identify the one or more users that match the particular profile, and may perform an action associated with or to accounts of the one or more users (or to the user accounts of the one or more users). Since the secondary matching process (which requires substantially more computer resources and time to perform) is performed based on a particular profile only when it is indicated that at least one user matches the particular profile, the overall profile matching process is more efficient than the conventional profile matching process as one or more profiles can be quickly skipped over when it is determined that no user matches the one or more profiles based on the preliminary matching process.

As the users of the service provider change (e.g., new users being added to service provider, users being removed from the service provider, user data of existing users being modified, etc.), the profile matching system may be required to perform the matching process again. However, since the changes of the users may only affect a portion of the user data set (and usually a small portion), performing the profile matching process for the entire data set may be inefficient. As such, in some embodiments, the profile matching system may generate an incremental data set to represent only the changes to the data set, and not the entire data set. The incremental data set only includes any updates (e.g., data associated with new users, updated data associated with existing users, etc.) that occurred after the previous matching. For example, after performing a profile matching process (e.g., either to the entire data set or the previous version of the incremental data set, etc.), the profile matching system may monitor changes to the user data. Whenever a change to the user data is detected, the profile matching system may update the data set and also the incremental data set.

In some embodiments, the profile matching system may also generate incremental filters to represent the presence of data in the incremental data set. As such, whenever a change to the user data is detected, the profile matching system may update the filters that represent data in the data set, and also update the incremental filters. When the change is associated with an addition of data to the data set (e.g., a new user registering with the service provider, an existing user adding a new phone number, etc.), the profile matching system may use the techniques disclosed herein to modify the filters and the incremental filters. For example, the profile matching system may apply the one or more functions to the new data to generate a set of filter keys. The profile matching system may then increment the values in the filters and the incremental filters that correspond to the set of filter keys.

When the change is associated with a removal of data from the data set (e.g., a user account is being removed/deleted, a user is removing a phone number from the contact information, etc.), the profile matching system may similarly apply the one or more functions to the data being removed to generate the set of filter keys. Unlike the process performed on the filters to add new data, the profile matching system may decrement the values (e.g., decrement by 1) in the filters that correspond to the set of filter keys. In some embodiments, for removal of data, the profile matching system does not update the incremental filters.

When the change is associated with a replacement of data in the data set (e.g., replacing a phone number, replacing an address, etc.), the profile matching system may first modify the filters using the techniques disclosed herein for removing the data being replaced, and then modify the filters and the incremental filters using the techniques disclosed herein for adding the replacement data to the data set.

With the separation between the data set and the incremental data set, the profile matching system may choose to perform the matching process to the entire data set (e.g., using the filters that represent data from the data set) or to the incremental data set (e.g., using the incremental filters). For example, the profile matching system may initially perform the profile matching process to the entire data set. Subsequently, the profile matching system may choose to perform the profile matching process to the incremental user data set, instead of performing the matching process to the entire user data set, to further improve the performance of the profile matching process.

In some embodiments, the profile matching system may perform the profile matching process, using the techniques disclosed herein, to the incremental user data set periodically (e.g., every day). After performing a profile matching process to the incremental user data set, the profile matching system may refresh the incremental user data set and the incremental filters by removing the data in the incremental data set and all of the values stored in the incremental filters, such that new incremental data can be added. However, when a new profile is obtained or generated (e.g., a new malicious user is detected, a new product is being promoted to targeted users, etc.), the profile matching system may perform the profile matching process to the entire data set (e.g., using the filters representing data in the data set) based on the new profile.

Under certain circumstances, the service provider may desire to assess new data being added to the data set in real time such that actions can be performed to the user account as quickly as possible to avoid potential losses to other users of the service provider. The filters and/or the incremental filters as disclosed above enable the profile matching system to quickly determine whether certain data (e.g., an attribute value in a profile) exists in the data set, but does not provide a way to perform the reverse matching (e.g., determining whether certain data, such as a name of a new user, exists in one of the profiles). As such, in some embodiments, the profile matching system may also generate profile filters for the profiles. Similar to the filters generated for the data set, the profile matching system may generate different profile filters for different attribute types associated with the profiles. As such, the profile matching system may generate a name profile filter that represents the names in the profiles, a network address profile filter that represents the network addresses in the profiles, a phone number profile filter that represents the phone numbers in the profiles, etc. Since some of these profiles might not have complete information, having separate profile filters for representing different attribute values in the profiles enables the profile matching system to determine matches based on any particular attribute values, even when the complete information is not available in the profiles.

When it is detected that new data is added to the data set (e.g., a new user being registered with the service provider, an existing user adding or replacing user data, etc.), the profile matching system may determine whether the new data matches any of the profiles using the profile filters. For example, the profile matching system may apply one or more functions associated with the profile filters to the new data to generate a set of filter keys. The profile matching system may access values in the profile filters that correspond to the set of filter keys, and may use the values in the profile filters to determine whether the new data matches any one of the profiles. If any of the filters indicate that the new data matches at least one of the profiles (e.g., having the same name, having the same network address, etc.), the profile matching system may perform an action to the user account or associated with the user corresponding to the new data. In these scenarios, it is unnecessary to identify exactly which profile that the new data matches. As long as the new data matches any one of the profiles, the profile matching system may characterize/classify the new data or the user associated with the new data (e.g., as a malicious user, as a targeted user for a particular product or service, etc.).

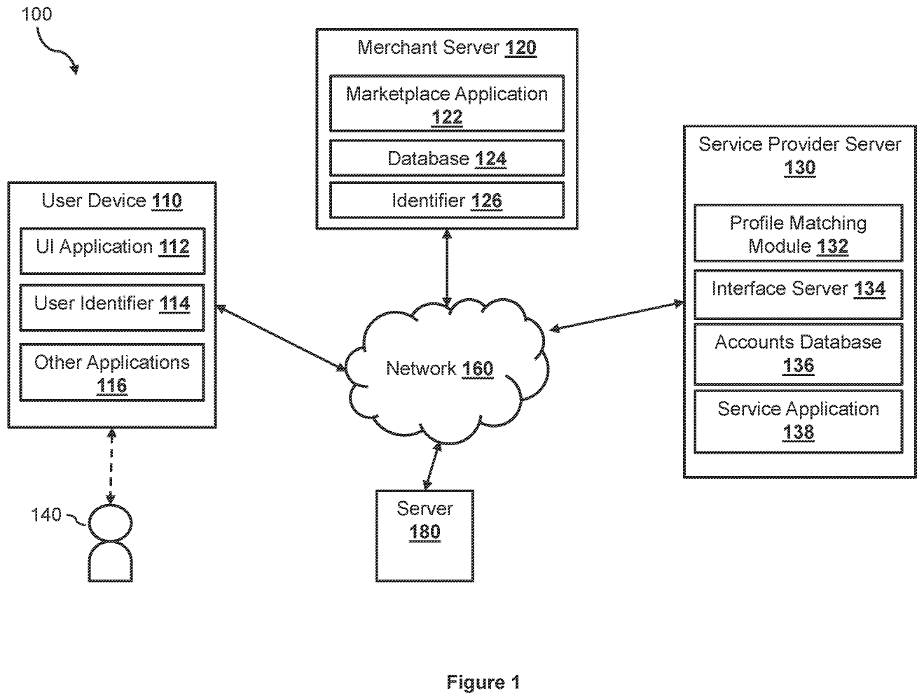

FIG. 1 illustrates an electronic transaction system 100, within which the profile matching system may be implemented according to one embodiment of the disclosure. The electronic transaction system 100 includes a service provider server 130, a merchant server 120, a user device 110, and a server 180 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120, the service provider server 130, and/or the server 180 over the network 160. For example, the user 140 may use the user device 110 to conduct an online transaction with the merchant server 120 via websites hosted by, or mobile applications associated with, the merchant server 120. The user 140 may also log in to a user account to access account services or conduct electronic transactions (e.g., data access, user registrations, account transfers, or electronic payments, etc.) with the service provider server 130. The user 140 may also log in to a user account to access account services or conduct electronic transactions (e.g., data access, user registrations, electronic payments, electronic purchase transactions, etc.) with the server 180. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130, the merchant server 120, and/or the server 180 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120, the service provider server 130, and/or the server 180.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to conduct a purchase transaction with the merchant server 120 and/or the service provider server 130, to initiate a chargeback transaction request, etc.).

While only one user device 110 is illustrated in FIG. 1, it has been contemplated that more than one user device (each having similar components as the user device 110 and capable to perform functions as the user device 110, and may be associated with different users) may exist within the electronic transaction system 100.

The merchant server 120, in various embodiments, may be maintained by a business entity (or in some cases, by a partner of a business entity that processes transactions on behalf of business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user device 110 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 (or a user of another user device) may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items and/or transactions are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

The server 180 may be maintained by an entity, such as a cybersecurity organization, that monitors malicious activities on the Internet and store information associated with the malicious activities (e.g., conducted a cyberattack, conducted fraudulent transactions, etc.). As such, the server 180 may generate profiles of various users who have conducted malicious activities or have data that can be used by the service provider server to generate the profiles of the malicious users. The server 180 may also generate profiles of various users who have conducted valid or authorized transactions.

The service provider server 130, in one embodiment, may be maintained by a transaction processing entity or an online service provider, which may provide processing of electronic transactions between users (e.g., the user of the user device 110) or between the users and one or more merchants. As such, the service provider server 130 may include a service application 138, which may be adapted to interact with the user device 110, the merchant server 120, and/or the server 180 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140, or a merchant associated with the merchant server 120, etc.) may access a user account associated with the user and access various services offered by the service provider server 130, by generating HTTP requests directed at the service provider server 130.

The service provider server 130, in one embodiment, may be configured to maintain one or more user accounts and merchant accounts in an accounts database 136, each of which may include account information associated with one or more individual users (e.g., the user 140 associated with user device 110, etc.) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a profile matching module 132 that implements the profile matching system as discussed herein. The profile matching module 132 may be configured to use one or more filters to perform a profile matching process on the data stored in the accounts database 136 using the techniques disclosed herein. The profile matching module 132 may determine if any users (or user accounts) match a particular profile (e.g., a malicious user profile, a targeted user profile, etc.). The profile matching module 132 may then perform one or more actions to the user accounts corresponding to the matched users. For example, the profile matching module 132 may suspend the user accounts or increase a security level associated with the user accounts when it is determined that the user accounts match one or more malicious user profiles. In another example, the profile matching module 132 may transmit electronic data corresponding to the product and/or service recommendation to devices associated with the user accounts when it is determined that the user accounts match one or more targeted user profiles.

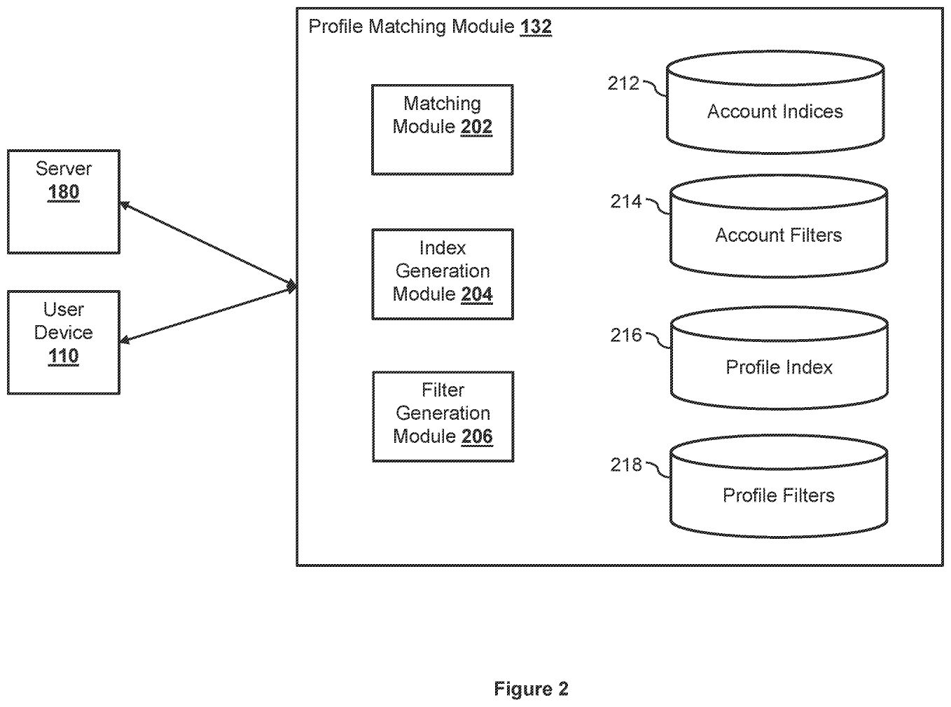

FIG. 2 illustrates an example schematic of the profile matching module 132 according to various embodiments of the disclosure. The profile matching module 132 includes a matching module 202, an index generation module 204, and a filter generation module 206. In some embodiments, the profile matching module 132 may access user data associated with various users of the service provider server 130 from the accounts database 136. Based on the user data, the index generation module 204 may generate one or more account indices 212 that would assist the profile matching module 132 to search for user accounts based on various attributes, such as a name, a phone number, a network address, etc. In some embodiments, in order to improve the profile matching process for the service provider server 130, the filter generation module 206 may also generate one or more account filters 214 based on the user data obtained from the accounts database 136. By accessing the values in the account filters 214, the matching module 202 may determine a presence or an absence of various data within the user data from the accounts database 136.

As discussed herein, the profile matching module 132 may generate, or otherwise obtain, profiles corresponding to one or more categories. For example, the profile matching module 132 may communicate with the server 180 that is configured to monitor activities (both malicious and authorized) conducted on the Internet. The profile matching module 132 may obtain information about the people behind the malicious activities, such as usernames used by the people conducting the malicious activities, device attributes (e.g., a type of device, a type of operating system, a network address, etc.) of devices used by the people conducting the malicious activities, other information (e.g., bank account numbers, phone numbers, addresses, etc.) associated with the malicious users. The server 180 may provide the data associated with various events (e.g., cyberattacks, fraudulent transactions, or other malicious activities conducted on the Internet) and the malicious users to the profile matching module 132. Based on the data, the profile matching module 132 may generate a set of profiles corresponding to malicious users. Each profile may include the information associated with a malicious user. It has been contemplated that only some of the information can be obtained for each malicious user, as the malicious user may be smart enough to obfuscate or hide some of the information, and/or the server 180 was not able to obtain all of the information associated with the malicious user.

In another example, the profile matching module 132 and/or the service provider server 130 may determine that one or more groups of users (also referred to as “targeted users”) may be interested in certain products and/or services based on the attributes of the users. For example, the profile matching module 132 and/or the service provider server 130 may determine that users who are between 20-30 years of age, live in California, and have purchased a first product in the last six months may be interested in a second product. As such, the profile matching module 132 may generate a profile for the targeted users. The profile may include information such as an age (or an age range), a location, and a transaction history of the first product. In some embodiments, the profile matching module 132 may also generate other profiles for identifying users who may be interested in other products and/or services offered by the service provider server 130, the merchant server 120, or other entities.

In some embodiments, the profile matching module 132 may also use the index generation module 204 to generate, based on the set of profiles, one or more profile indices 216 that would assist the profile matching module 132 to search for profiles based on various attributes, such as a name, a phone number, a network address, a location, etc. In some embodiments, in order to improve the profile matching process for the service provider server 130, the filter generation module 206 may also generate one or more profile filters 218 based on the set of profiles. By accessing the values in the profile filters 218, the matching module 202 may determine a presence or an absence of various data within the profiles.

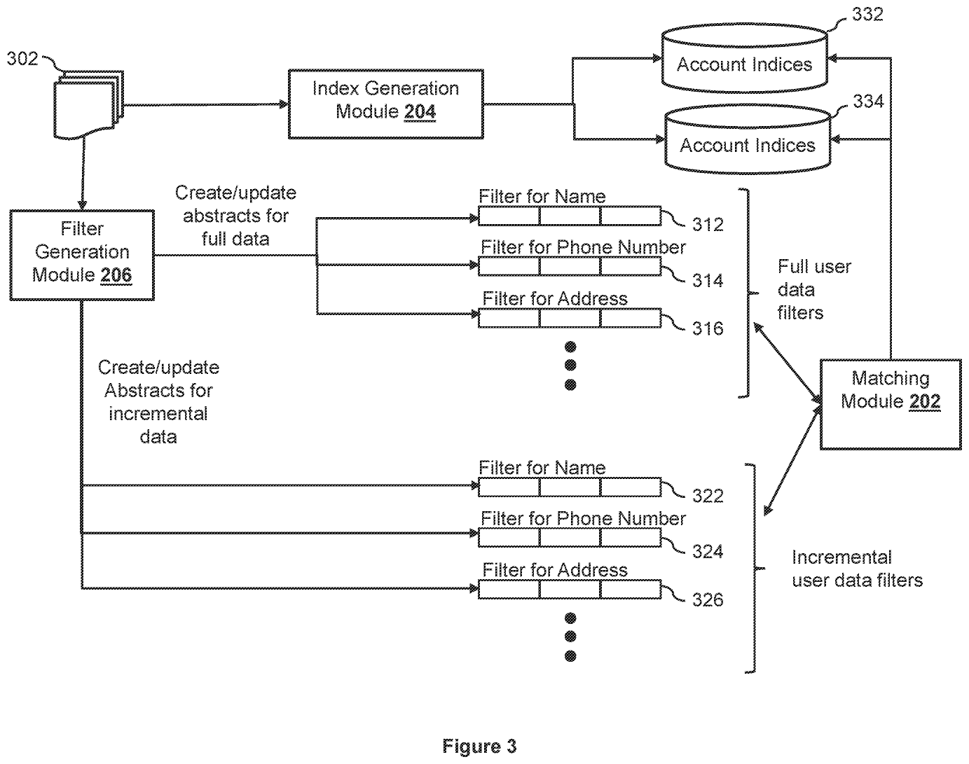

FIG. 3 illustrates example operations of generating the account indices and the account filters for the service provider server 130 according to various embodiments of the disclosure. In this example, the profile matching module 132 may obtain user data 302 comprising attribute values of the users of the service provider server 130. The user data 302 may be obtained from the accounts database 136, and may include multiple user data records, where each user data record stores attribute values (e.g., a name, an address, network addresses of devices, etc.) associated with a different user of the service provider server 130. The profile matching module 132 may provide the user data 302 to the index generation module 204 and the filter generation module 206. As discussed herein, the index generation module 204 may generate one or more account indices 332 that would assist the profile matching module 132 to search for user accounts based on various attributes, such as a name, a phone number, a network address, etc. In some embodiments, the account indices 332 may be implemented as a type of search index (e.g., an inverted index, an Apache Lucene® storage-based index, etc.). By querying the account indices 332 using one or more attribute values, the matching module 202 may determine one or more user records that include the one or more attribute values (which corresponds to one or more users who are associated with the one or more attribute values). As such, in some embodiments, the index generation module 204 may traverse the user data records in the user data 302, extract the attribute values from each user data record, and generate the one or more account indices 332 based on mappings between the attribute values and the user data record from which the attribute values were extracted.

In some embodiments, the filter generation module 206 may generate one or more filters (e.g., filters 312, 314, and 316, etc.) based on the user data 302. As discussed herein, different filters may be generated for different attribute types based on the user data. Thus, the filter generation module 206 may generate a number of filters based on the number of attribute types associated with the user data 302. For example, when the user data 302 includes ten different attribute types (e.g., a name attribute type, a phone number attribute type, a network address attribute type, etc.) that are usable for matching the profiles, the index generation module 206 may generate ten different filters, each filter generated for a different attribute type. In this example, based on the user data 302, the filter generation module 206 may generate a filter 312 for the name attribute type, a filter 314 for the phone number attribute type, a filter 316 for the address attribute type, and other filters.

Each of the filters 312.314, and 316 may be implemented using a data structure (e.g., a vector, an array of values, etc.) for storing values that indicates the presences of different data in the user data 302. Each filter may have m dimensions (e.g., an array of m values, etc.) corresponding to m number of keys (also referred to herein as “filter keys”). For example, each filter may include filter keys within the range of 0 and (m−1). Each filter may also be associated with one or more functions (e.g., hash functions), which can be used to map data to different filter keys (e.g., k number of keys) of the filter. In some embodiments, the functions associated with one filter may be different from the functions associated with another filter. In some embodiments, the filter generation module 206 may determine the m value and the k value for each of the filters 312, 314, and 316 based on the characteristics of the attribute values within the user data 302 that correspond to the corresponding attribute type. For example, the profile matching module 132 may determine the m value and the k value for each filter based on the number of data records (e.g., which corresponds to the number of user accounts) in the user data 302, a number of different attribute values corresponding to the attribute type within the user data 302 (a number of different names, a number of different addresses, etc.), the attribute type itself, and/or other factors. In some embodiments, the filter generation module 206 may determine the same m value and the same k value for every filter generated based on the user data 302 if the attribute values across the different attribute types have similar characteristics. In some embodiments, the filter generation module 206 may determine different m values and/or different k values for different filters generated based on the user data 302 if the attribute values across the different attribute types have different characteristics.

To generate a filter based on the user data 302, the filter generation module 206 may first create a data structure (e.g., an array of values, etc.) for the filter. In one example, the filter generation module 206 may create an array for each of the filters 312, 314, and 316 based on the m values determined for the corresponding filters. The filters 312, 314, and 316 may be initialized with zeros. The index generation module 206 may then incorporate (e.g., add) information derived from the user data 302 into the filters 312, 314, and 316.

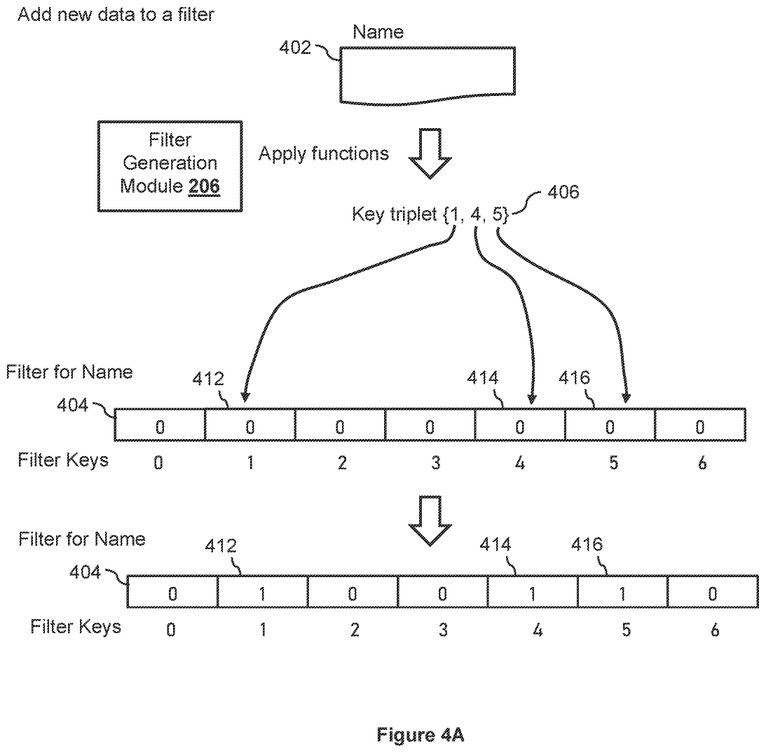

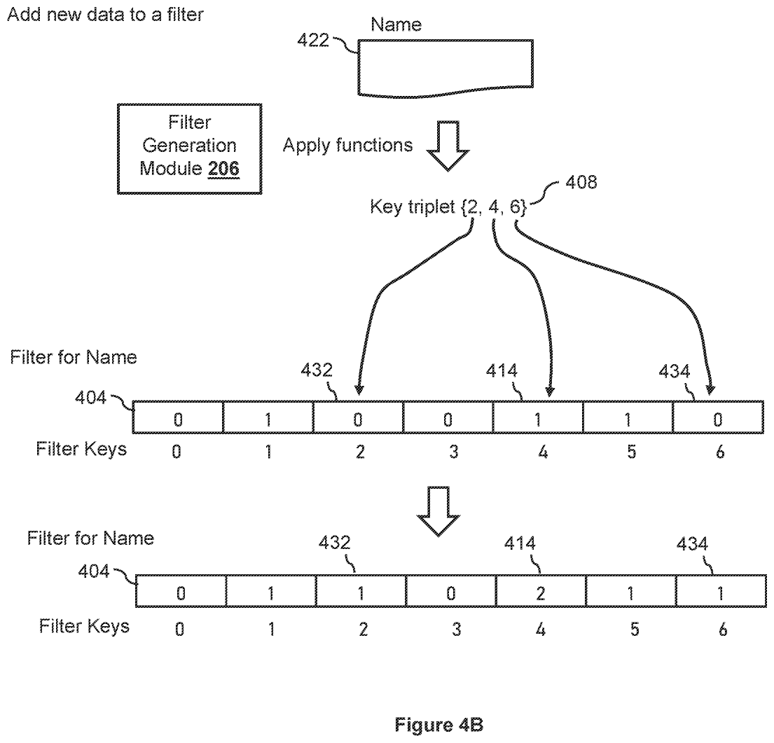

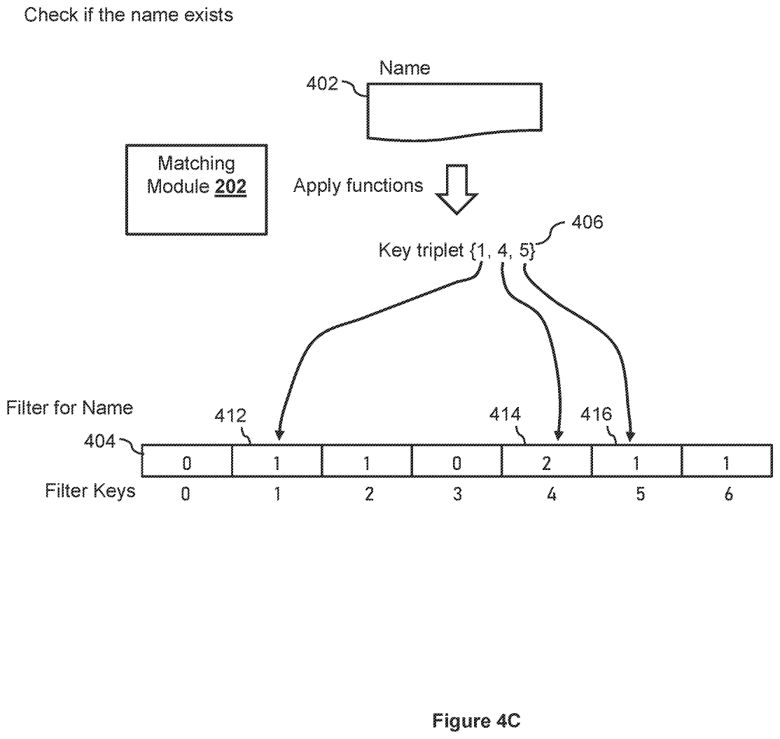

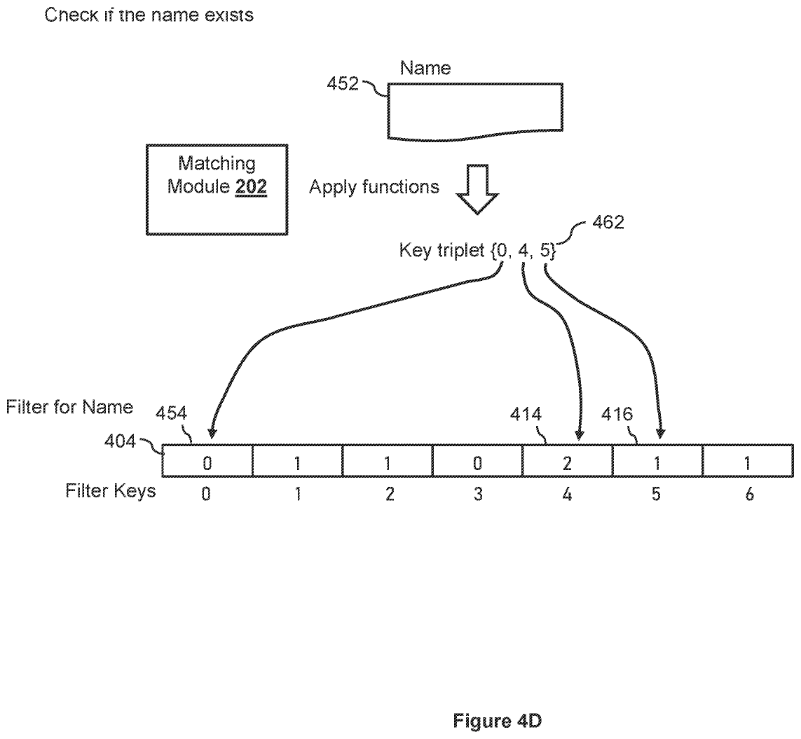

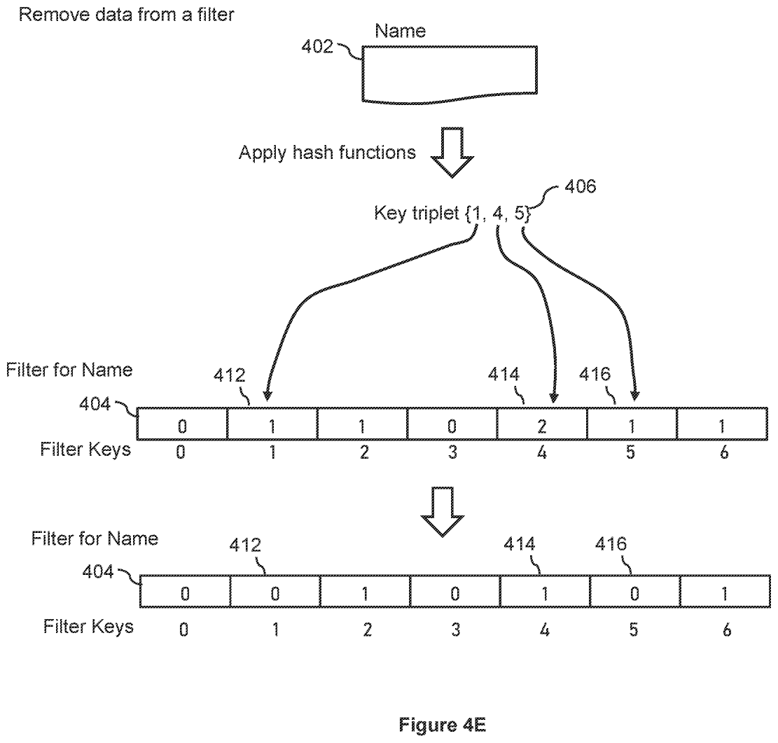

FIGS. 4A and 4B illustrate the operations of incorporating new data into a filter according to various embodiments of the disclosure. In FIG. 4A, a new name 402 is being incorporated into a filter 404 corresponding to the name attribute type. In some embodiments, the filter 404 may correspond to the filter 312. In this example, the filter 404 was implemented as an array of seven values. Each of the values may correspond to a filter key (between the number 0 and 6). The filter generation module 206 may also initialize the filter 404 to zeros. As shown in FIG. 4A, the filter 404 initially includes all zeros: {0, 0, 0, 0, 0, 0, 0}.

The filter 404 may also be associated with one or more functions that can be used to generate filter keys for different attribute values (e.g., different names). The name 402 may be extracted from a user data record from the user data 302. Once the name 402 has been extracted from the user data 302, the filter generation module 206 may apply the one or more functions associated with the filter 404 to generate a set of filter keys 406. In this example, since the filter 404 is associated with three different functions (e.g., three hash functions), the index generation module 206 may determine three filter keys 406 based on applying the functions to the name 402 (applying a first function to the name 402 generates the key value of ‘1,’ applying a second function to the name 402 generates the key value of ‘4,’ and applying a third function to the name 403 generates the key value of ‘5’). The filter keys 406 indicate which values in the filter 404 should be modified for incorporating the name 402 into the filter 404. As such, the filter generation module 206 may access the values corresponding to the filter keys 406. In this example, the set of filter keys 406 includes the keys of ‘1,’ ‘4,’ and ‘5.’ The filter generation module 206 may then access the values 412, 414, and 416 in the filter 404 that correspond to the keys ‘1,’ ‘4,’ and ‘5,’ and increment each of the values 412, 414, and 416 by one. After incorporating the name 402 into the filter 404, the filter 404 now includes the values of {0, 1, 0, 0, 1. 1, 0}, as shown in FIG. 4A.

In FIG. 4B, another name 422 is being incorporated into the filter 404 by the filter generation module 206. Similar to the operations shown in FIG. 4A, the filter generation module 206 may again apply the functions to the name 422 to generate a set of keys 408. In this example, the set of filter keys 408 includes the keys of ‘2,’ ‘4,’ and ‘6.’ The filter generation module 206 may then access the values 432, 414, and 434 in the filter 404 that correspond to the keys ‘2,’ ‘4,’ and ‘6,’ and increment each of the values 432, 414, and 434 by one. Since the values 432 and 434 were zeros before incorporating the name 422 into the filter 404, the values 432 and 434 have both been turned into ones by the filter generation module 206. On the other hand, since the value 414 was one (based on the incorporation of the name 402 into the filter 404), the filter generation module 206 may turn the value 414 from one to two. After incorporating the name 422 into the filter 404, the filter 404 now includes the values of {0, 1, 1, 0. 2, 1, 1}, as shown in FIG. 4B. Using the techniques disclosed herein to incorporate the different names from the user data 302 into the filter 404, the filter 404 may now indicate the presence or absence of various names in the user data 302 without storing any of the actual names in the filter 404.

FIGS. 4C and 4D illustrate the operations of checking the presence of various names in the user data 302 using the filter 404 according to various embodiments of the disclosure. In FIG. 4C, the matching module 202 may use the filter 404 to determine whether the name 402 is included in the user data 302. The matching module 202 may apply the functions associated with the filter 404 to the name 402 to generate the keys 406, which includes the key values ‘1,’ ‘4,’ ‘5.’ The matching module 202 may access the values 412, 414, and 416 in the filter 404 that correspond to the keys 406. In this example, after incorporating the names 402 and 422 into the filter 404, the filter 404 includes the values {1, 2, 1} at the locations corresponding to the keys 1,’ ‘4,’ ‘5.’ If the name 402 has been incorporated into the filter 404, all of the values corresponding to the keys 406 would be non-zeros (e.g., have been incremented at least once based on the incorporation of the name 402 into the filter 404). As such, the matching module 202 may determine that the name 402 is present (or likely to be present) in the user data 302 since all of the values in the filter 404 that correspond to the keys 406 are non-zeros.

In FIG. 4D, the matching module 202 may use the filter 404 to determine whether a name 452 (a name that has not been incorporated into the filter 404) is included in the user data 302. The matching module 202 may apply the functions associated with the filter 404 to the name 452 to generate the keys 406, which includes the key values ‘0,’ ‘4,’ ‘5.’ The matching module 202 may access the values 454, 414, and 416 in the filter 404 that correspond to the keys 462. In this example, the filter 404 includes the values {0, 2, 1} at the locations corresponding to the keys ‘0,’ ‘4,’ ‘5.’ Thus, the matching module 202 may determine that the name 452 is absent from the user data 302, since at least one of the values in the filter 404 that correspond to the keys 406 is zero.

Using the techniques disclosed herein to construct the filters (e.g., the filters 312, 314, 316, 404, etc.), the filters can be updated when certain data that has been incorporated into the filters is removed from the user data 302. This is particular advantageous because user data and/or profile data can change over time. For example, new users may register new user accounts with the service provider server 130, existing users may request user accounts to be removed from the service provider server 130, and/or existing users may request to update user data associated with their user accounts. When new data is added to the user data 302 (e.g., when new users registering new user accounts with the service provider server 130, etc.), the filter generation module 206 may use the same techniques as discussed above by reference to FIGS. 4A and 4B to incorporate the new data into the filter 404. When data is removed from the user data 302, the filter generation module 206 use a reverse process to remove the data that has been incorporated into the filter 404.

FIG. 4E illustrates the operations for removing data from a filter according to various embodiments of the disclosure. In the example illustrated in FIG. 4E, the name 402 is being removed from the filter 404. After receiving a request to remove the name 402 from the filter 404, the filter generation module 206 may apply the functions associated with the filter 404 to generate the set of filter keys 406, which include the keys of ‘1,’ ‘4,’ and ‘5.’ The filter generation module 206 may then access the values 412, 414, and 416 in the filter 404 that correspond to the keys ‘1,’ ‘4,’ and ‘5.’ As shown in FIG. 4E, the filter 404 includes the values of {0, 1, 1, 0, 2, 1, 1}, and the values 412, 414, and 416 corresponding to the locations represented by the keys ‘1,’ ‘4,’ and ‘5’ are {1, 2, 1}. Instead of incrementing the values (if we were to incorporate new data into the filter 404), the filter generation module 206 may decrement each of the values 412, 414, and 416 by one. After removing the name 402 from the filter 404, the filter 404 now includes the values of {0, 0, 1, 0, 1, 0, 1}, as shown in FIG. 4E.

Referring back to FIG. 3, once the account indices 212 and the various filters 312, 314, 316, etc. have been created for the service provider server 130 based on the user data 302, the matching module 202 may begin performing profile matching on the user data 302 using the techniques disclosed herein. To perform the profile matching process on the user data 302, the matching module 202 may perform a preliminary matching process using the various filters (e.g., the filters 312, 314, and 316, etc.) that were generated to represent the various attribute types of the user data 302. The matching module 202 may access the attribute values in each of the profiles, and may use the corresponding filters to determine whether any user(s) of the service provider server 130 matches each of the profiles.

For example, the matching module 202 may access an attribute value of a first profile (e.g., the name in the first profile). The matching module 202 may then apply one or more functions associated with the filter 312 to the name in the first profile to generate a set of filter keys. The matching module 202 may access the values in the filter 312 based on the filter keys, and may determine whether any user(s) of the service provider server 130 matches the profile based on the values in the filter 312 (e.g., by determining whether all of the values are non-zeros, etc.). The matching module 202 may perform the same steps for other attribute values in the profile (e.g., the phone number, the network address, etc.) using the filters 314, 316, and other filters. If it is determined that no users match the first profile, the matching module 202 may skip the first profile, and perform the preliminary matching process for the next profile (e.g., a second profile).

On the other hand, if it is determined that at least one user of the service provider server 130 matches the first profile based on the filters 312, 314, 316, etc., the matching module 202 may perform a secondary matching process. For example, the matching module 202 may then query the account indices 212 for one or more user records from the user data 302 based on the matched attribute value(s). Using the account indices 212, the identity (or identities) of one or more users that match the first profile can be determined, and actions may then be performed on the user accounts of the one or more users. While the account indices 212 can provide more information than the filters (e.g., the user records that match a profile can be accurately identified, etc.), querying the account indices 212 typically requires more computer resources and more time than using the filters. By using the filters to eliminate at least a portion of the profiles that do not have any matches with the user data 302 before querying against the account indices 212, the efficiency of the profile matching process can be substantially improved.

As the users of the service provider server 130 change (e.g., new users being added to service provider, users being removed from the service provider, user data of existing users being modified, etc.), the profile matching module 132 may be required to perform the profile matching process again. However, since the changes of the users may only affect a portion of the user data set (and usually a small portion), performing the profile matching process for the entire user data 302 may be inefficient. As such, in some embodiments, the profile matching system may generate incremental user data based on the changes to the data set, such that the incremental user data only includes the new data, but not the entire user data 302. In some embodiments, the incremental user data only includes any updates (e.g., data associated with new users, updated data associated with existing users, etc.) that occurred since the previous profile matching process has been completed. For example, after performing a profile matching process (e.g., either to the entire user data 302 or a previous version of the incremental user data, etc.), the profile matching module 132 may monitor changes to the user data 302. Whenever a change to the user data 302 is detected, the profile matching module 132 may update the user data 302 and also the incremental user data.

In some embodiments, the index generation module 204 may generate one or more indices 334 (also referred to as “account indices” or “search indices”) for representing the incremental user data. The one or more indices 334 may assist the matching module 202 to search for user accounts based on various attributes, such as a name, a phone number, a network address, etc. In some embodiments, the indices 334 may be implemented as a type of search index (e.g., an inverted index, an Apache Lucene® storage-based index, etc.). In some embodiments, the filter generation module 206 may also generate incremental filters (e.g., filters 322, 324, 326, etc.) to represent the presences of data in the incremental user data. As such, whenever a change to the user data 302 is detected, the profile matching module 132 may not only update the indices 332 and the filters 312, 314, 316, etc. that represent the entire user data 302, but also update the indices 334 and the filters 322, 324, 326, etc. that represent the incremental user data using the techniques disclosed herein.

With the separation between the indices 332 and the filters 312, 314, 316, etc. that represent the entire user data 302, and the indices 334 and the filters 322, 324, 326, etc. that represent only the incremental user data, the matching module 202 may choose to perform the matching process to the entire user data 302 (e.g., using the indices 332 and the filters 312, 314, 316, etc.) or to the incremental data set (e.g., using the indices 334 and the filters 322, 324, 326, etc.). For example, the matching module 202 may initially perform the profile matching process to the entire user data 302 using the indices 332 and the filters 312, 314, 316, etc. Subsequently, the matching module 202 may choose to perform the profile matching process to the incremental user data using the indices 334 and the filters 322, 324, 326, etc., instead of performing the profile matching process to the entire user data 302, to further improve the performance of the profile matching process.

In some embodiments, the matching module 202 may perform the profile matching process, using the techniques disclosed herein, to the incremental user data periodically (e.g., every day). After performing a profile matching process to the incremental user data, the profile matching module 132 may refresh the incremental user data (and also the indices 334 and the filters 322, 324, 326, etc.) by removing the data in the indices and resetting the values to zeros in the filters. When a new profile is obtained or generated (e.g., a new malicious user is detected, a new product is being promoted to targeted users, etc.), the matching module 202 may perform the profile matching process to the entire user data 302 (e.g., using the indices 332 and the filters 312, 314, 316, etc.) based on the new profile.

Under certain circumstances, the service provider may desire to assess new data being added to the user data 302 in real time such that actions can be performed to the user account(s) as quickly as possible to avoid potential losses to other users of the service provider. The account indices and account filters that represent the user data 302 as disclosed above enable the matching module 202 to quickly determine whether certain data (e.g., an attribute value in a profile) exists in the user data 302, but does not provide a way to perform reverse matching (e.g., determining whether certain data, such as a name of a new user, exists in one of the profiles). As such, in some embodiments, the profile matching module 132 may also generate profile indices and/or profile filters for the profiles.

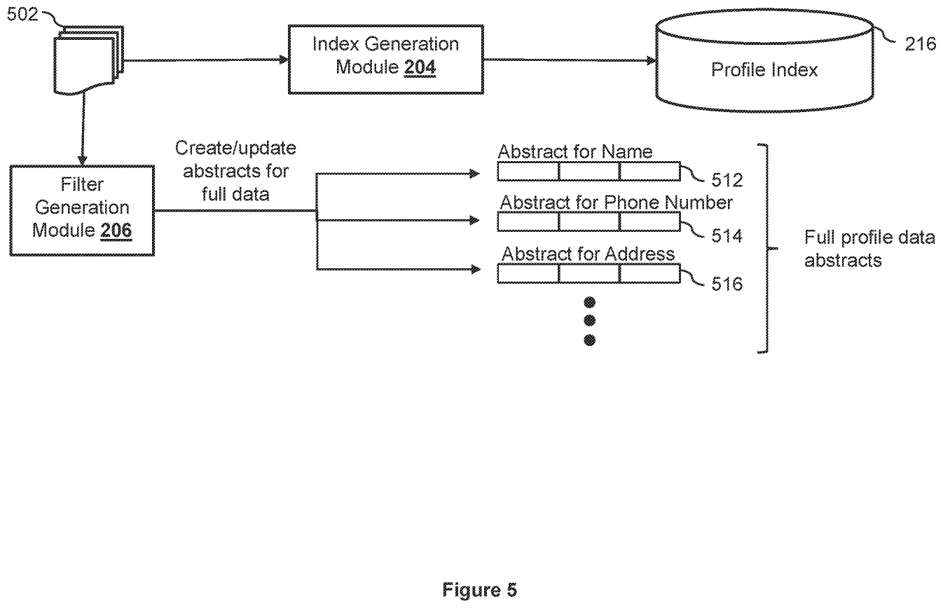

FIG. 5 illustrates example operations of generating the profile indices and the profile filters for the service provider server 130 according to various embodiments of the disclosure. In this example, the profile matching module 132 may obtain a set of profiles 502. As discussed herein, the set of profiles 502 may be obtained from the server 180 or generated by the profile matching module 132, and may include multiple profile records, where each profile record stores attribute values (e.g., a name, an address, network addresses of devices, etc.) associated with a different profile corresponding to a category (e.g., malicious users, targeted users, etc.). The profile matching module 132 may provide the set of profiles 502 to the index generation module 204 and the filter generation module 206. As discussed herein, the index generation module 204 may generate one or more account indices 216 that would assist the matching module 202 to search for profiles based on various attributes, such as a name, a phone number, a network address, etc. In some embodiments, the profile indices 216 may be implemented as a type of search index (e.g., an inverted index, an Apache Lucene® storage-based index, etc.). By querying the profile indices 216 using one or more attribute values, the matching module 202 may determine one or more profiles that include the one or more attribute values (e.g., an attribute value associated with a new user, etc.). As such, in some embodiments, the index generation module 204 may traverse the set of profiles 502, extract the attribute values from each profile, and generate the one or more profile indices 216 based on mappings between the attribute values and the profile from which the attribute values were extracted. In some embodiments, the profile matching module 132 may opt to not generate the profile index 216 for the set of profiles, since it is typically unnecessary to identify the exact profile that matches the user data 302.

In some embodiments, the filter generation module 206 may generate one or more filters (e.g., filters 512, 514, and 516, etc.) based on the set of profiles 502. As discussed herein, different filters may be generated for different attribute types based on the profiles. Thus, the filter generation module 206 may generate a number of filters based on the number of attribute types associated with the set of profiles 502. For example, based on the set of profiles 502, the filter generation module 206 may generate a filter 512 for the name attribute type, a filter 514 for the phone number attribute type, a filter 516 for the address attribute type, and other filters.

When it is detected that new data is added to the user data 302 (e.g., a new user being registered with the service provider, an existing user adding or replacing user data, etc.), the matching module 202 may determine whether the new data matches any of the profiles using the profile filters 512, 514, 516, etc. For example, the matching module 202 may extract a phone number from the new data. The matching module 202 may then apply one or more functions associated with the profile filter 514 to generate a set of filter keys. The matching module 202 may then access the values within the profile filter 514 that correspond to the filter keys, and determine whether the new data matches any of the profiles based on the values. In these scenarios, it is generally unnecessary to identify exactly which profile that the new data matches (and as such, the profile matching module 132 may opt to not construct the profile index 216 in some embodiments). As long as the new data matches any one of the profile, the profile matching module 132 may characterize the new data, or the user associated with the new data (e.g., as a malicious user, as a targeted user for a particular product or service, etc.), and perform one or more actions on or associated with the user account.

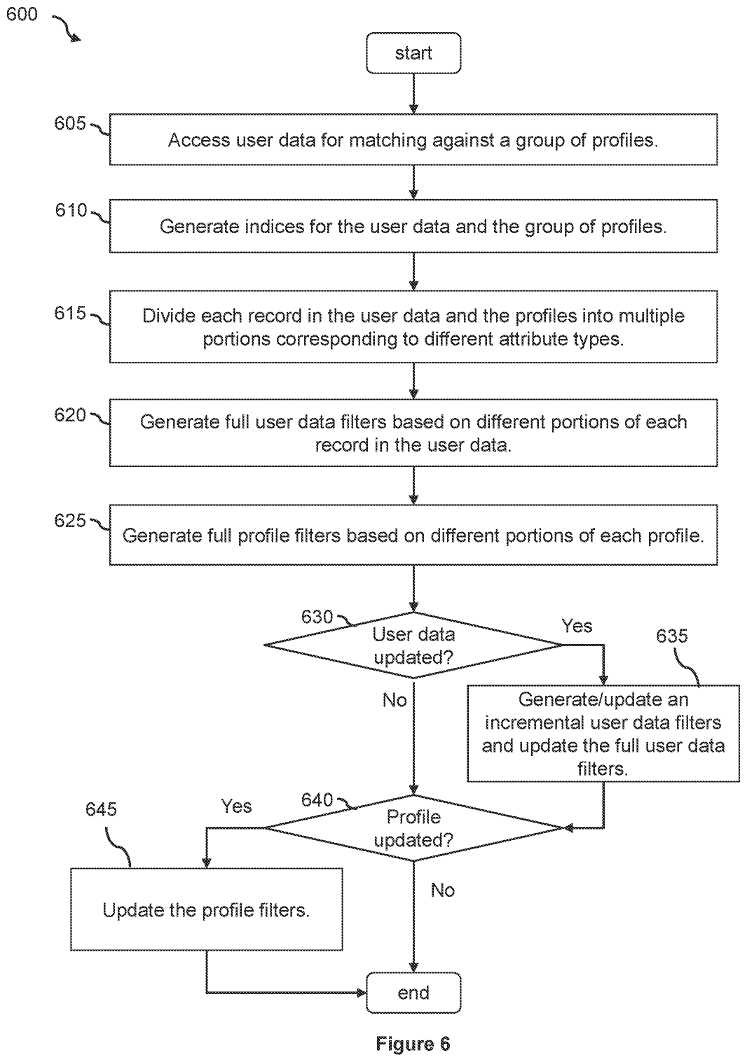

FIG. 6 illustrates a process 600 for generating indices and filters for performing the profile matching processes according to various embodiments of the disclosure. In some embodiments, at least a portion of the process 600 may be performed by the profile matching module 132. The process 600 begins by accessing (at step 605) user data for matching against a group of profiles and generating (at step 610) indices for the user data and the group of profiles. For example, the profile matching module 132 may obtain user data 302 from the accounts database 136 of the service provider server 130. The index generation module 204 may generate one or more search indices based on the user data 302 and a set of profiles.

The process divides (at step 615) each record in the user data and the profiles into multiple portions corresponding to different attribute types, and then generates (at step 620) full user data filters based on different portions of each record in the user data and generates (at step 625) full profile filters based on different portions of each profile. For example, the filter generation module 206 may extract attribute values from each record in the user data 302, and may incorporate the attribute values in the corresponding filters 312, 314, 316, etc. using the techniques disclosed herein (as illustrated in FIGS. 4A and 4B). Similarly, the filter generation module 206 may also extract attribute values from each profile in the set of profiles 502, and may incorporate the attribute values in the corresponding filters 512, 514, 516, etc.

The process determines (at step 630) if the user data is updated, and generates or updates (at step 635) an incremental user data filters and update the full user data filters if it is determined that the user data is updated. For example, in addition to generating the full user data filters (e.g., filters 312, 314, 316, etc.), the filter generation module 206 of some embodiments may also generate incremental user data filters (e.g., filters 322, 324, 326, etc.) that represents only changes to the user data 302 (incremental user data). The filters 322, 324, 326 may be initialized with zeros. When it is detected that user data 302 has been updated, the filter generation module 206 may also update the filters 322, 324, 326, etc. by incorporating the updated data into the filters 322, 324, 326, etc.

The process also determines (at step 640) whether there is any update to the profiles, and updates (at step 645) the profile filters if it is determined that there is an update to the profiles. For example, where it is detected an update to the profiles (e.g., a new profile being generated, an existing profile being removed, an existing profile being modified, etc.), the filter generation module 206 may update the profile filters 512. 514, 516 using the techniques disclosed herein. After the user data filters and the profile filters are generated, the matching module 202 may begin performing profile matching processes either to the entire user data 302 or to the incremental data. In some embodiments, if it is detected that the user data 302 is updated, the matching module 202 may also perform a real-time profile matching process using the profile filters 512, 514, 516, etc.

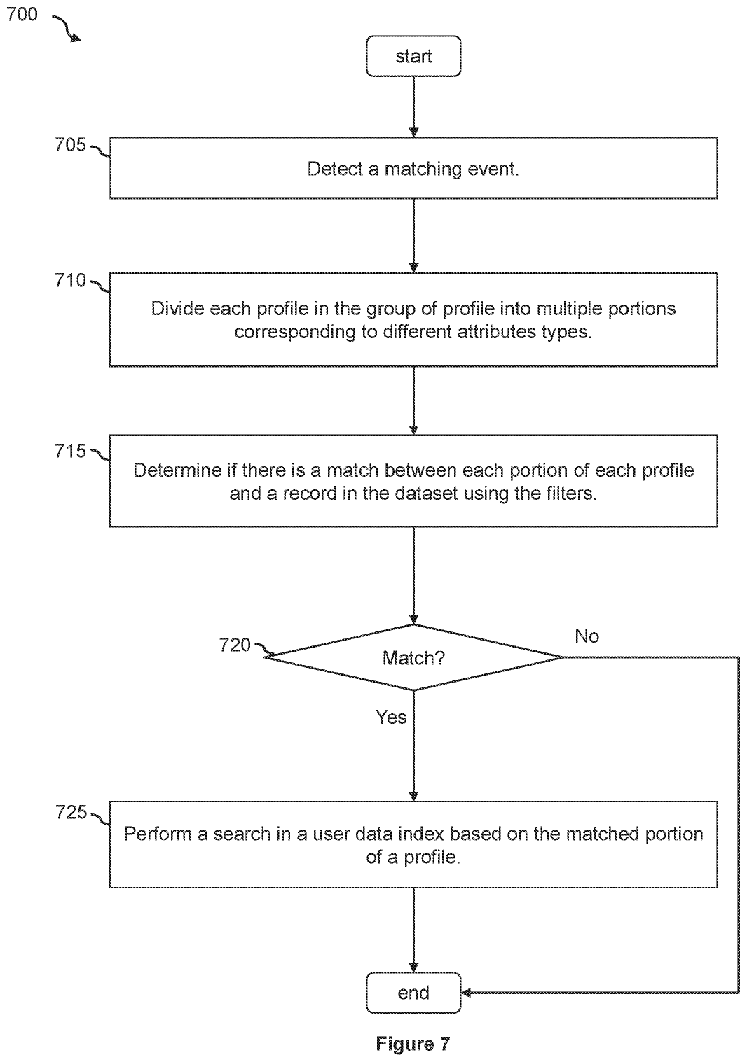

FIG. 7 illustrates a process 700 for performing the profile matching process according to various embodiments of the disclosure. In some embodiments, at least a portion of the process 700 may be performed by the profile matching module 132. The process 700 begins by detecting (at step 705) a matching event. In some embodiments, profile matching module 132 may determine one or more conditions for performing a profile matching process. For example, the profile matching module 132 may determine that a profile matching process should be performed on the incremental user data on a periodic basis (e.g., every day, every week, etc.). In addition, the profile matching module 132 may determine to initiate a profile matching process on all user data (e.g., the user data 302) when the set of profiles is updated (e.g., a new profile is generated/obtained, an existing profile is modified, etc.). As such, the matching module 202 may monitor for any of such events. A detection of any of these events may trigger an initiation of a profile matching process.

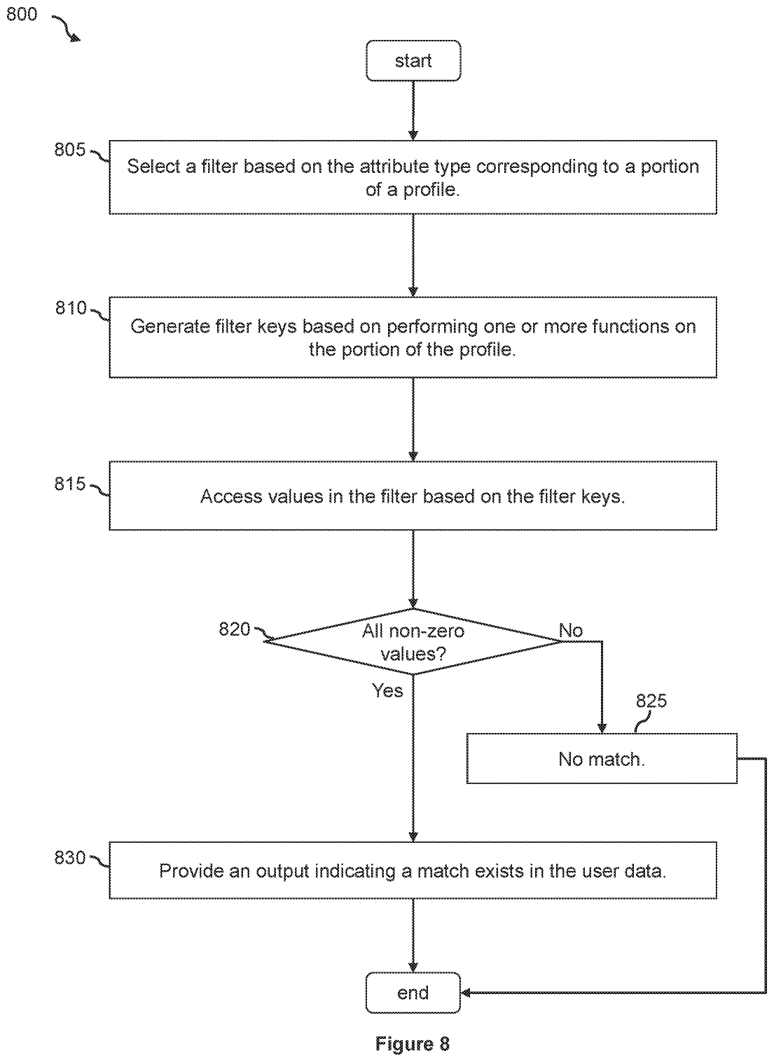

The process then divides (at step 710) each profile in the group of profile into multiple portions corresponding to different attribute types, and determines (at step 715) if there is a match between each portion of each profile and a record in the dataset using the filters. For example, the matching module 202 may extract attribute values corresponding to the different attribute types from each profile in the set of profiles. The matching module 202 may also access the various filters that represent the user data 302, such as the filters 312, 314, 316, etc. The matching module may use the filters 312, 314, 316, etc. to determine if any of the attribute values from the profiles is present in the user data 302. In some embodiments, the step 715 for determining whether a match exists between a portion of a profile and the user data will be explained in more details below by reference to FIG. 8.

The process determines (at step 720) if there is a match between the user data and the profiles, and performs (at step 725) a search in a user data index based on the matched portion of a profile if a match exists between the user data and the profiles. For example, if the matching module 202 determines that an attribute value of a profile is present in the user data 302, the matching module 202 may perform a secondary matching process based on the attribute value. In some embodiments, the matching module 202 may query the account indices 332 based on the attribute value. Based on the querying, the matching module 202 may obtain an identifier indicating a user account of a user that matches the profile based on the attribute value (e.g., the user having the same phone number as the profile). The profile matching module 132 or another module in the service provider server 130 may then perform an action to or associated with the user account.

FIG. 8 illustrates a process 800 for determining a match between a profile and user data using one or more filters according to various embodiments of the disclosure. In some embodiments, at least a portion of the process 800 may be performed by the profile matching module 132. The process 800 begins by selecting (at step 805) a filter based on the attribute type corresponding to a portion of a profile. For example, after extracting an attribute value corresponding to a particular attribute type (e.g., a network address) from a profile, the matching module 202 may select, from the different filters (e.g., the filters 312, 314, 316, etc.), a filter corresponding to the particular attribute type (e.g., the filter 316 corresponding to the network address attribute type).

The process then generates (at step 810) filter keys based on performing one or more functions on the portion of the profile and accesses (at step 815) values in the filter based on the filter keys. For example, the matching module 202 may apply the one or more functions associated with the selected filter (e.g., the filter 316) on the attribute value (e.g., the network address in the profile) to obtain a set of filter keys. The set of filter keys can be used by the matching module 202 to identify the locations within the filter 316. As such, the matching module 202 may access the values in the filter 316 that correspond to the filter keys.

The process determines (at step 820) whether all of the values accessed from the filter are non-zeros. The process determines (at step 825) that there is no match between the attribute value and the user data when at least one value accessed from the filter is a zero, and determines that a match exists between the attribute value and at least one record in the user data when all of the values accessed from the filter is non-zeros. The process then provides (at step 830) an output indicating a match exists in the user data.

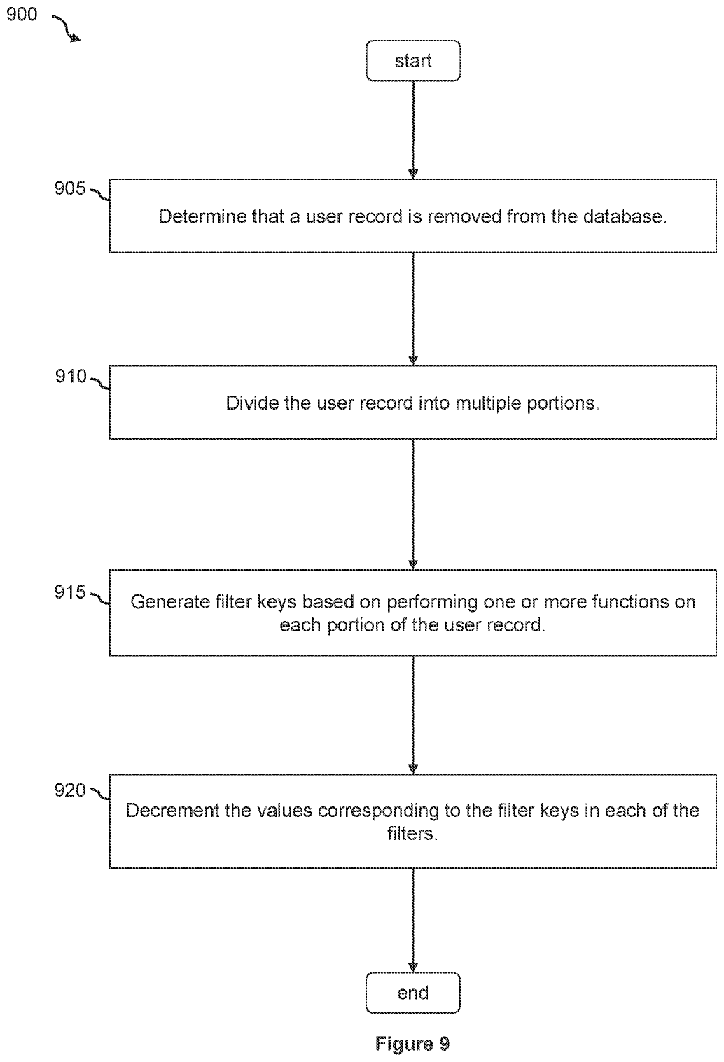

FIG. 9 illustrates a process 900 for removing a reference to data from a filter according to various embodiments of the disclosure. In some embodiments, at least a portion of the process 900 may be performed by the profile matching module 132. The process 900 begins by determining (at step 905) that a user record is removed from the database. For example, an existing user of the service provider server 130 may decide to delete a user account with the service provider server 130. In another example, an existing user may request to replace existing user data (e.g., a phone number) with replacement user data (e.g., a new phone number). The profile matching module 132 may update the corresponding filter (e.g., a phone number filter 314) based on the change to the user data.

The process divides (at step 910) the user record into multiple portions, generates (at step 915) filter keys based on performing one or more functions on each portion of the user record and decrements (at step 920) the values corresponding to the filter keys in each of the filters. For example, the index generation module 206 may apply one or more functions associated with the filter (e.g., the filter 314) to obtain a set of filter keys. The index generation module 206 may then decrement each of the values in the filter 314 that corresponds to the set of filter keys by one.

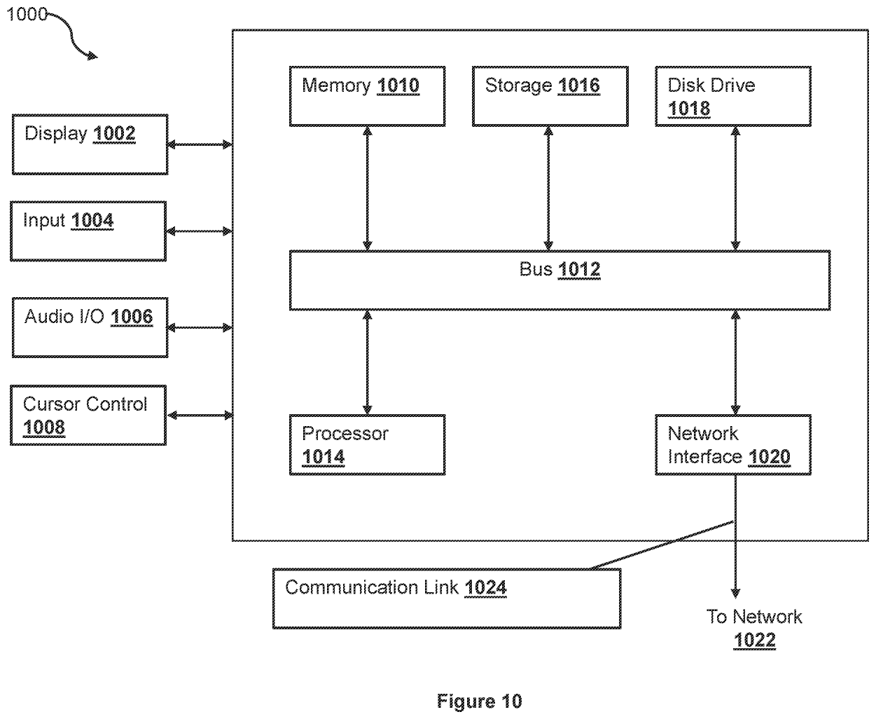

FIG. 10 is a block diagram of a computer system 1000 suitable for implementing one or more embodiments of the present disclosure, including the service provider server 130, the merchant server 120, the user device 110, and the server 180. In various implementations, the user device 110 may include a mobile cellular phone, personal computer (PC), laptop, wearable computing device, etc. adapted for wireless communication, and each of the service provider server 130, the merchant server 120, and the server 180 may include a network computing device, such as a server. Thus, it should be appreciated that the devices 110, 120, 130, and 180 may be implemented as the computer system 1000 in a manner as follows.

The computer system 1000 includes a bus 1012 or other communication mechanism for communicating information data, signals, and information between various components of the computer system 1000. The components include an input/output (I/O) component 1004 that processes a user (i.e., sender, recipient, service provider) action, such as selecting keys from a keypad/keyboard, selecting one or more buttons or links, etc., and sends a corresponding signal to the bus 1012. The I/O component 1004 may also include an output component, such as a display 1002 and a cursor control 1008 (such as a keyboard, keypad, mouse, etc.). The display 1002 may be configured to present a login page for logging into a user account or a checkout page for purchasing an item from a merchant. An optional audio input/output component 1006 may also be included to allow a user to use voice for inputting information by converting audio signals. The audio I/O component 1006 may allow the user to hear audio. A transceiver or network interface 1020 transmits and receives signals between the computer system 1000 and other devices, such as another user device, a merchant server, or a service provider server via a network 1022. In one embodiment, the transmission is wireless, although other transmission mediums and methods may also be suitable. A processor 1014, which can be a micro-controller, digital signal processor (DSP), or other processing component, processes these various signals, such as for display on the computer system 1000 or transmission to other devices via a communication link 1024. The processor 1014 may also control transmission of information, such as cookies or IP addresses, to other devices.

The components of the computer system 1000 also include a system memory component 1010 (e.g., RAM), a static storage component 1016 (e.g., ROM), and/or a disk drive 1018 (e.g., a solid-state drive, a hard drive). The computer system 1000 performs specific operations by the processor 1014 and other components by executing one or more sequences of instructions contained in the system memory component 1010. For example, the processor 1014 can perform the profile matching functionalities described herein, for example, according to the processes 600, 700, 800, and 900.

Logic may be encoded in a computer readable medium, which may refer to any medium that participates in providing instructions to the processor 1014 for execution. Such a medium may take many forms, including but not limited to, non-volatile media, volatile media, and transmission media. In various implementations, non-volatile media includes optical or magnetic disks, volatile media includes dynamic memory, such as the system memory component 1010, and transmission media includes coaxial cables, copper wire, and fiber optics, including wires that comprise the bus 1012. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 1000. In various other embodiments of the present disclosure, a plurality of computer systems 1000 coupled by the communication link 1024 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
detecting an event associated with a user account;
accessing a plurality of filters corresponding to a plurality of attribute types, wherein each filter in the plurality of filters represents a presence of different attribute values corresponding to a corresponding attribute type in a group of user profiles;
in response to detecting the event, extracting, from data associated with the user account, a first portion of the data corresponding to a first attribute type in the plurality of attribute types;
generating a plurality of filter keys based on the first portion of the data associated with the user account;
accessing a plurality of values in a first filter of the plurality of filters corresponding to the first attribute type based on the plurality of filter keys;
determining a likelihood that the user account matches a user profile in the group of user profiles based on the plurality of values; and
performing an action associated with the user account based on the likelihood the user account matches the user profile.

2. The system of claim 1, wherein the event is associated with a registration of the user account.

3. The system of claim 1, wherein the event is associated with an update to the user account.

4. The system of claim 1, wherein the determining the likelihood that the user account matches the user profile in the group of user profiles comprises:
determining whether each value in the plurality of values comprises a non-zero value.

5. The system of claim 1, wherein the operations further comprise:
determining that the likelihood that the user account matches the user profile in the group of user profiles is above a threshold based on the plurality of values, wherein the action comprises suspending the user account.

6. The system of claim 1, wherein the operations further comprise:
determining that the likelihood that the user account matches the user profile in the group of user profiles is above a threshold based on the plurality of values, wherein the action comprises providing customized content based on the user profile on a user device associated with the user account.

7. The system of claim 1, wherein the operations further comprise:
receiving a request to remove the user profile from the group of user profiles;
generating a second plurality of filter keys based on performing the plurality of functions on profile data associated with the user profile;
accessing a second plurality of values in a second filter of the plurality of filters based on the second plurality of filter keys; and
decrementing the second plurality of values in the second filter.

8. A method, comprising:
accessing a plurality of filters corresponding to a plurality of attribute types, wherein each filter in the plurality of filters represents a presence of different attribute values corresponding to a corresponding attribute type in a plurality of user accounts;
retrieving profile data associated with a profile from a group of profiles;
generating a plurality of filter keys based on a first portion of the profile data;
accessing a plurality of values in a first filter of the plurality of filters corresponding to a first attribute type based on the plurality of filter keys;
determining a likelihood that at least one user account in the plurality of user accounts matches the profile in the group of profiles based on the plurality of values; and
in response to determining that the likelihood exceeds a threshold, performing a search among the plurality of user accounts based on the profile data.

9. The method of claim 8, further comprising:
identifying a user account that matches the profile based on the search; and
performing an action associated with the user account.

10. The method of claim 9, wherein the action comprises suspending the user account.

11. The method of claim 9, wherein the action comprises providing customized content based on the profile on a user device associated with the user account.

12. The method of claim 8, wherein the generating the plurality of filter keys comprises performing a plurality of hash functions on the first portion of the profile data.

13. The method of claim 8, wherein the search is performed using an inverted index generated based on user data associated with the plurality of user accounts.

14. The method of claim 8, further comprising:
comparing each of the plurality of values against zero, wherein the likelihood is determined further based on the comparing.

15. A non-transitory machine-readable medium having stored thereon machine-readable instructions executable to cause a machine to perform operations comprising:
obtaining an attribute value associated with a user account and corresponding to an attribute type;
selecting, from a plurality of filter, a particular filter that corresponds to the attribute type, wherein the particular filter includes information that indicates a presence of different attribute values corresponding to the attribute type in a set of user profiles;
generating a set of filter keys based on applying one or more functions to the attribute value;
accessing a plurality of values that corresponds to the set of filter keys in the particular filter;
classifying the user account based on the plurality of values; and
performing an action associated with the user account based on the classifying.

16. The non-transitory machine-readable medium of claim 15, wherein the operations further comprise:
receiving a request to add a user profile to the set of user profiles;
generating a second set of filter keys based on performing the one or more functions on profile data of the user profile that corresponds to the attribute type;
accessing a second plurality of values that corresponds to the second set of filter keys in the particular filter; and
incrementing each of the second plurality of values in the particular filter.

17. The non-transitory machine-readable medium of claim 15, wherein the one or more functions comprises a hash function.

18. The non-transitory machine-readable medium of claim 15, wherein the classifying the user account comprises:
classifying the user account as a first category when each value in the plurality of values comprises a non-zero value.

19. The non-transitory machine-readable medium of claim 18, wherein the operations further comprise:
in response to classifying the user account as the first category, suspending the user account.

20. The non-transitory machine-readable medium of claim 18, wherein the operations further comprise:
in response to classifying the user account as the first category, providing customized content based on the first category on a user device associated with the user account.
